(19) United States
(12) Patent Application Publication
(10) Pub. No.: US 2024/0314237 A1
(43) Pub. Date: Sep. 19, 2024

(54) SYSTEM AND METHOD OF IDENTIFYING CALL HANDLING OF INCOMING CALLS

(71) Applicant: Doximity, Inc., San Francisco, CA (US)

(72) Inventors: Ricardo Mauricio Garcia Fernandez, Beaverton, OR (US); Aaron Arthur Gray, Birmingham, AL (US); Emmanuel Lagarrigue Lazarte, Bahia Blanca (AR); Andrew Porterfield, Noblesville, IN (US); Elizabeth Doris Marie Stephenson, Port St. Lucie, FL (US)

(21) Appl. No.: 18/122,648

(22) Filed: Mar. 16, 2023

(51) Int. Cl. H04M 3/436; H04M 3/42

(52) U.S. Cl. CPC H04M 3/436; H04M 3/42059

(57) ABSTRACT

A system and method identifies call handling of an incoming call to allow corrective action to be taken to promote trust of a caller identifier used to make the call. The method includes receiving, from a mobile device associated with a spam filter, a request for a phone call. The phone call to the mobile device is initiated using a caller identifier. Call log data is received from the mobile device indicating whether the phone call was flagged as spam by the spam filter. A notification is generated in response to the call log data indicating that the phone call was flagged as spam. Other embodiments are described and claimed.

### TECHNICAL FIELD

This disclosure generally relates to phone calls. In particular, this disclosure relates to identifying handling of incoming calls to promote trust in caller identifiers.

### BACKGROUND

Mobile carriers determine whether and how an incoming call is treated. For example, an incoming call associated with a caller identifier, such as a phone number, may be blocked and/or displayed to a recipient as being potentially spam. The mobile carriers may work with third party analytics vendors to screen incoming calls and determine how to treat the call. Such determinations are made through black box algorithms that are typically not made public. Accordingly, callers may not know how their calls are being presented to recipients, or whether they are being seen at all.

### BRIEF DESCRIPTION OF THE DRAWINGS

Embodiments and implementations of the present disclosure will be understood more fully from the detailed description given below and from the accompanying drawings of various aspects and implementations of the disclosure, which, however, should not be taken to limit the disclosure to the specific embodiments or implementations, but are for explanation and understanding only.

FIG. 1 is a diagram illustrating an example network architecture in accordance with one or more embodiments of the disclosure.

FIG. 2 is a flowchart of an example method of identifying call handling of an incoming call in accordance with one or more embodiments of the disclosure.

FIG. 3 is a flow diagram of interactions of system components during a method of identifying call handling in accordance with one or more embodiments of the disclosure.

FIG. 4 is a flow diagram of operations performed by a mobile device during a method of identifying spam flagging of a caller identifier in accordance with one or more embodiments of the disclosure.

FIGS. 5-6 are pictorial views of a user interface for adding a caller identification profile in accordance with an embodiment of the disclosure.

FIG. 7 is a block diagram of an example computing device that may perform one or more of the operations described herein, in accordance with some embodiments.

### DETAILED DESCRIPTION

A caller, such as a physician, may call a recipient, such as a patient, to communicate information, e.g., to provide health-related services. The physician may place the call from a personal mobile device, however, the physician may prefer that the patient see the phone number of the incoming call as that of the healthcare facility whom the physician represents for that health-related service, rather than from the personal mobile device. The physician may therefore place the call through a software application running on the personal mobile device, which substitutes a phone number of the healthcare facility as the caller identifier delivered with the call. As described below, such legitimate phone number substitution may be used to cause the patient to see the incoming call as coming from the healthcare facility, even when the call is placed from the personal mobile device.

When a caller uses a phone number substitution as a caller identifier, the caller may be unaware of how the substituted phone number will be treated by a mobile carrier of the recipient. More particularly, the algorithms used to decide how to handle the call, e.g., caller identification or spam filtering algorithms, are opaque to the caller. The algorithms may, however, cause (1) display of the incoming phone number (the substitute phone number), (2) display of a publicly registered caller name (CNAM value), (3) display the call as “Spam” or “Spam Likely,” and/or (4) block the call. Thus, in at least some cases, the call may not reach the recipient or may be seen by the recipient as being spam even though the substituted phone number is originating from a legitimate caller with valuable and beneficial intent. Any corrective action, such as unblocking or resolving spam flagging of the substitute phone number, may require the recipient to retroactively report the incorrectly handled call to the caller to allow the caller to then address the matter with the mobile carrier and/or select an alternative substitute phone number. The recipient may be unlikely to initiate this process, however, and there remains a need to identify handling, such as spam flagging, of incoming calls to allow corrective actions to be taken proactively.

In an embodiment, a system and method observes the end-user experience of receiving calls through different mobile carriers and calling plans to determine how the calls are handled. For example, the system and method can identify spam flagging of a caller identifier. The system and method can include a testing infrastructure of one or more mobile devices with cellular contracts that can receive and log data about incoming calls. The logged data can be used to identify caller identifiers that are being blocked or flagged as spam, perhaps incorrectly. Such identification can allow corrective action to be taken to promote trust in the caller identifier so the caller identifier is displayed to the recipient without a spam-likely designation. A recipient, such as a patient, may therefore be more likely to trust and answer a call from a caller, e.g., a physician, who is using the caller identifier to make the call.

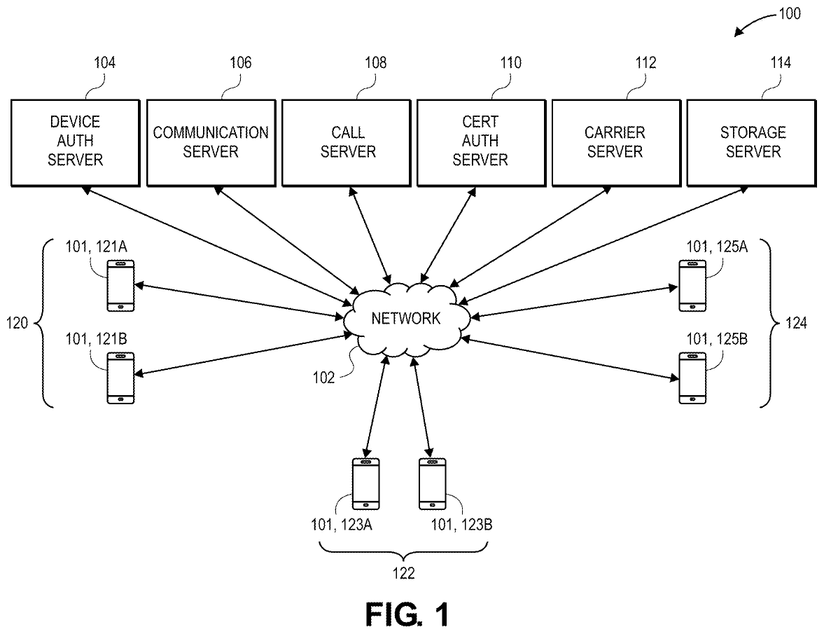

FIG. 1 is a diagram illustrating an example network architecture, in accordance with one or more embodiments of the disclosure. A network architecture 100 includes a network 102 interconnecting one or more computing devices 101, e.g., mobile device(s), with one or more other system components, including a device authorization server 104, a communication server 106, a call server 108, a certification authority server 110, a carrier server 112, and/or a storage server 114. More particularly, the system components can be in data communication with each other through the network 102.

Examples of computing devices 101 may include, but are not limited to, a mobile device, e.g., a smartphone, a tablet computer, or a laptop computer, or a desktop computer, etc. The mobile devices 101 can be owned by a single entity. The mobile devices 101 may be grouped into two or more groups based on integrated circuits installed in and/or contained by the mobile devices 101. More particularly, each mobile device 101 can contain an integrated circuit, such as a Subscriber Identification Module (SIM) card, associated with a mobile carrier, phone settings, and/or mobile contract types. By way of example, a first group 120 of mobile devices 101 can include at least two mobile devices 101 containing SIM cards associated with a first mobile carrier. The first group 120 can include: a first mobile device 121A containing a first SIM card associated with a first contract having standard caller identification services, and a second mobile device 121B containing a second SIM card associated with an second contract having expanded caller identification and spam filtering services. Similarly, a second group 122 can include at least two mobile devices 101 containing SIM cards associated with a second mobile carrier, including: at least one mobile device 123A containing a SIM card associated with standard caller identification services, and a second mobile device 123B containing a second SIM card associated with expanded caller identification and spam filtering services. To continue the example, a third group 124 can include at least two mobile devices 101 containing SIM cards associated with a third mobile carrier, including: at least one mobile device 125A containing a SIM card associated with standard caller identification services, and a second mobile device 125B containing a second SIM card associated with expanded caller identification and spam filtering services. Accordingly, the mobile devices 101 can be grouped by respective mobile carriers, phone settings, and contract types such that call handling by the mobile devices 101 of the system can provide insight into how each of the mobile devices 101 configurations influence handling of received calls.

The mobile devices 101 of the system can simulate computing devices owned by other users, such as patients, who use services and/or products provided by one or more service providers, such as healthcare providers. More particularly, such users may use a computing device to communicate with one or more service providers, and in the event that such computing devices have SIM cards associated with the same mobile carriers, phone settings, and contract types as the mobile devices 101 in the system, the treatment of calls from the service providers can be assumed to be the same.

Healthcare providers may be people who provide health related services and/or products to the user. Examples of healthcare providers may include, but are not limited to, doctors, pharmacists, dentists, nurses, therapists, psychologists, technicians, surgeons, etc. Each healthcare provider may use a computing device (e.g., smartphone, tablet computer, etc.) to communicate with one or more of the users of the service providers. Communications between the healthcare provider and the user may be one-directional communications. For example, the healthcare provider can initiate a call to a user such that a computing device of the user receives the call. The call may be made using a substituted phone number, as described above. If the user calls this number back, they may be connected to, e.g., a facility having the phone number that was substituted, rather than the computer device that initiated the call. Accordingly, by simulating the call handling performed by similar patient mobile devices, the mobile devices 101 of the system can simulate call handling of such substituted numbers. For example, the mobile devices 101 of the system can determine whether the substituted numbers are likely to be flagged as spam.

The other components of the system can operate interactively to place calls to the mobile devices 101, and to monitor how such calls are handled by the mobile devices 101. Such operations are described in more detail below. The individual system components are described next.

A device authorization server 104 can provide authorization for other system components to interact. For example, the device authorization server 104 can perform a device authorization handshake with one or more of the mobile devices 101, as described below, to grant permission to the mobile devices 101 to make requests of another system component, such as a communication server 106.

In an embodiment, the communication server 106 may connect with one or more of the networked mobile devices 101 to facilitate call requests that will initiate phone calls to the mobile devices 101. For example, a mobile device 101 may include one or more software applications, as described below, to cause a call to be placed from the communication server 106 to the mobile device 101. The software applications running on the mobile device 101 can cause the call to be answered and terminated, and can log data from the call that may be used to identify spam flagging of the call. More details regarding phone call initiation and completion are provided below. The communication server 106 can pass along information about the call to the call server 108.

The call server 108 can initiate the call to a carrier server 112, which will connect the phone call to the mobile devices 101. The call server 108 can create and send a request message that initiates the call using a signaling protocol, e.g., the Session Initiation Protocol. The call server 108 can make the call request using the information passed along by the communication server 106. The call server 108 may be referred to as an originating service provider.

The certification authority server 110 can confirm verification and/or verify phone numbers as being associated with known entities, such as healthcare facilities. As described below, such functionality can allow for attestation splitting of phone calls to the mobile devices 101.

The carrier server 112 can complete the call to the mobile device 101. The call may be communicated through additional, intermediate servers between the call server 108 and the carrier server 112 (not shown). The carrier server 112 can be maintained by a same or different entity than that which maintains the call server 108. For example, the carrier server 112 and/or the call server 108 may be maintained by an entity that provides communication tools for making and receiving phone calls, sending and receiving text messages, and performing other communication functions. The communication functions can be performed through web service application programming interfaces, for example. In an embodiment, the carrier server 112 is maintained by a mobile carrier. The mobile carrier can be a carrier associated with the integrated circuit installed in the mobile device 101 receiving the phone call. The carrier server 112 may be referred to as a terminating service provider. The terminating service provider can determine whether and how to send the phone call to the recipient device.

The storage server 114 can be a cloud server providing storage accessed on demand by other system components. For example, the storage server 114 can store logged data received from the mobile devices 101 after completion of the phone call. The logged data may indicate how the call was handled, e.g., whether the call was flagged as spam.

Processes described below may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, the processes may be performed by the various components of the system, including the servers and mobile devices 101 described above.

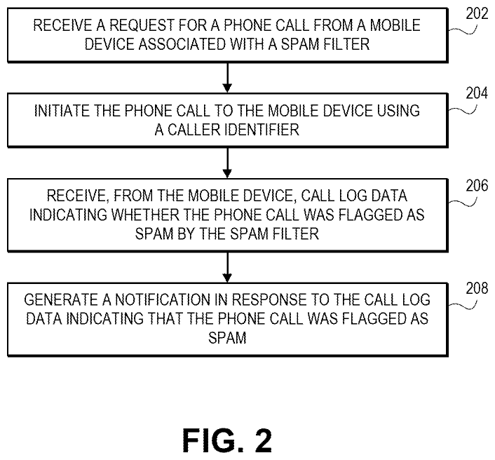

FIG. 2 is a flowchart of an example method of identifying call handling of an incoming call in accordance with one or more embodiments of the disclosure. The method includes several operations that will be described in more detail below. In summary, the method can include requesting, receiving, and reporting a phone call by a mobile device 101 equipped with a SIM card associated with a mobile carrier and a phone plan. At operation 202, a request for a phone call is received from the mobile device 101 associated with the phone plan, e.g., a mobile plan including a spam filter. At operation 204, the phone call is initiated to be sent to the mobile device 101 using a caller identifier, e.g., a phone number. For example, the phone call can be sent with the caller identifier indicating a substituted phone number used by a physician. At operation 206, call log data is received from the mobile device 101. The call log data can indicate whether the phone call was flagged as spam by the spam filter. Accordingly, the call log data indicates whether the substituted phone number is treated as spam by the mobile carrier and/or mobile plan. At operation 208, corrective actions can be taken in the event that the call log data indicates the phone call was flagged as spam. For example, a notification can be generated in response to the indication. The notification may be used to promote selection of a trustworthy substitute number, for example. Other notification may be generated, as described below.

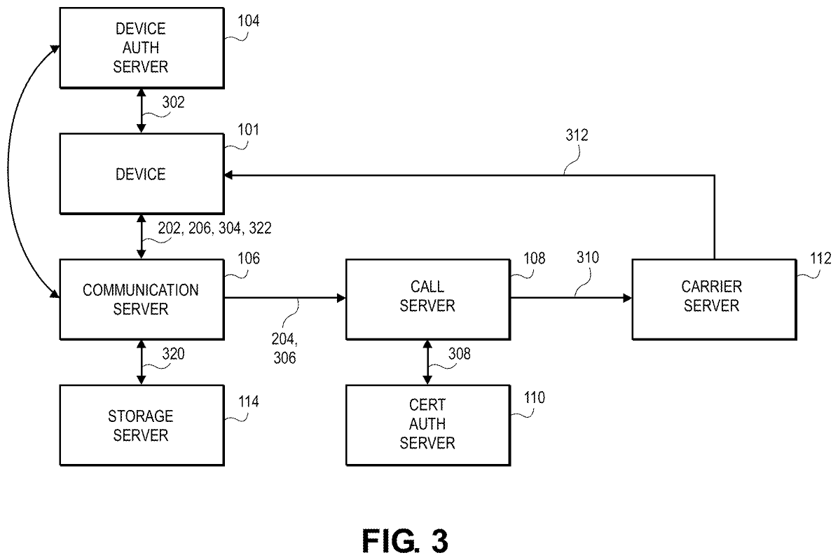

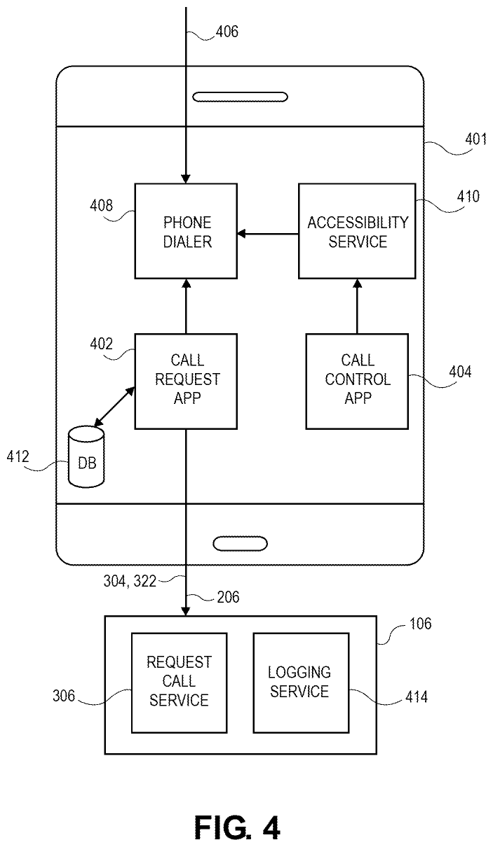

FIGS. 3-4 are illustrative of a method of testing call handling performed by different carriers and/or different call handling policies. The figures represent operations of a common method, and thus, the figures are alternately referred to below.

FIG. 3 is a flow diagram of interactions of system components during a method of identifying call handling of an incoming call in accordance with one or more embodiments of the disclosure. The interactions are between system components and a single mobile device 101 to assess call handling performed by the single mobile device 101. It will be appreciated, however, that the method may be performed using each of the mobile devices 101 in the network architecture 100. There may be many such devices operating continuously throughout a day to assess call handling of numerous caller identifiers, e.g., substitute phone numbers. For example, the first group 120, the second group 122, and the third group 124 may have subgroups of 9 first devices and 9 second devices operating with different spam filters. The total number of mobile devices 101 in the network architecture 100 can therefore be 54 devices. Such numbers are not restrictive but are rather intended to demonstrate the scale of calls that can be handled per day. When the calls are processed according to the methodology described below, the sets of devices having respective combinations of mobile carrier and level of call screening can receive and handle about 950 calls per day. Such volume of calls can add up to testing approximately 1.2 million caller identifiers each month. Accordingly, the system described herein is scalable to identify spam flagging of many caller identifiers, including substitute phone numbers associated with healthcare providers throughout the world.

FIG. 4 is a flow diagram of operations performed by a mobile device during a method of identifying call handling of an incoming call in accordance with one or more embodiments of the disclosure. Each of the mobile devices 101 in the system are set up to perform the method. Setting up the mobile devices 101 includes installing instances of software applications configured to perform the operations of the method. The software applications can include a call request application 402 configured to generate requests to receive calls and to export call log data, and a call control application 404 configured to answer and terminate the received calls. When the software applications are installed, the method can be initiated through user elements of a graphical user interface, e.g., a start button.

Referring again to FIG. 3, upon initiation of the method, the call request application 402 may authenticate itself with an application programming interface (API) configured to generate calls from the communication server 106. The authentication can include, at operation 302, a device authentication handshake between the mobile device 101 and the device authorization server 104. More particularly, the call request application 402 running on the mobile device 101 can authenticate itself with an API on the device authorization server 104, using an Oauth strategy. The authorization can grant permission to the call request application 402 to perform service-to-service HTTP request 304 from the mobile device 101 to the API configured to generate calls from the communication server 106. More particularly, the API on the device authorization server 104 can return a token to the call request application 402 that the API on the communication server 106 can use to determine that call request 304 from the call request application is authorized. Accordingly, the communication server 106 can receive, from the device authorization server 104, authentication data authenticating the call request application 402. The authentication can permit the mobile device 101 to receive phone calls initiated by the communication server 106, as described below.

Following setup and authentication of the mobile device 101 with the communication server 106, referring both to FIGS. 3 and 4, at operation 202 the communication server 106 can receive the request 304 for a phone call from the mobile device 101. The request 304 for the phone call can be received from the call request application 402 running on the mobile device 101. The request 304 from the mobile device 101 can designate the mobile device as the device to receive the call. For example, the request 304 may indicate that the mobile device 101 is ready to receive calls, and can include a unique identifier of the mobile device, e.g., a phone number associated with the SIM card installed in the mobile device. Accordingly, the same device that requests the call can receive the call initiated from the communication server 106 and produced by the call server 108.

Referring to FIG. 3, at operation 204, the phone call can be initiated to the mobile device 101 using a caller identifier, e.g., a phone number, substituted phone number, etc. The communication server 106 can select the caller identifier for testing. More particularly, selection of the caller identifier may be based on a policy to test caller identifiers that are regularly used, not recently tested, and/or likely to be flagged as spam. More details on the selection and call scheduling policy are provided below. It will presently be understood, however, that the caller identifier is selected to identify how the caller identifier is handled such that corrective actions may be taken, if needed, to promote trust and willingness of recipients to answer calls originated with the caller identifier.

The system may introduce randomization into the method to cause the calling process to simulate calls occurring in uncontrolled, real-world environments. More particularly, the calling process can simulate non-automated calls placed with the caller identifier to ensure that the call is handled in the same manner that non-automated calls are handled. There is evidence that handling of automated calls by mobile carriers is performed differently than handling of non-automated calls, and thus, simulating natural calling processes can result in information about how the caller identifier would be treated if, for example, it is used as a substitute phone number by a physician. Stated differently, randomization of the calling process can ensure that the system does not influence call handling, and thus, can lead to more representative data about how calls are actually treated by mobile carriers.

The communication server 106 can initiate the phone call by sending a call initiation request 306 to the call server 108. The communication server 106 can perform a lookup of call source data based on the caller identifier. For example, the communication server 106 can determine the caller identifier that should be tested based on previous usage and testing patterns. The call source data can be included in the call initiation request 306.

In response to receiving the call initiation request 306, the call server 108 can perform attestation splitting. More particularly, at operation 308, the call server 108 can communicate with the certification authority server 110 to determine whether the caller identifier exists within a table of the certification authority server 110 that permits a predetermined attestation rating. The certification authority server 110 can be controlled by an entity that provides real-time information and/or analytics for various industries, such as the telecommunications industry. For example, the certification authority server 110 can provide clearinghouse or directory services to such industries. In an embodiment, the certification authority server 110 can confirm verification and/or verify phone numbers as being associated with healthcare facilities. In response to such confirmation and/or verification, the certification authority server 110 can provide a certificate that can be checked to permit an attestation rating, e.g., an “A” attestation rating, to be applied to calls associated with the verified phone numbers.

At operation 310, the call server 108 can create and send a request message, with either an “A” attestation rating or a “B” attestation rating. The “A” attestation rating indicates successful verification of the phone number. The “B” attestation rating indicates unsuccessful verification of the phone number. The request message initiates the call using a signaling protocol, e.g., the Session Initiation Protocol. The call server 108 can make the call request using the call source data provided by the communication server 106. For example, the information passed along by the communication server 106 can include the selected caller identifier. Thus, the call server 108 can originate the phone call to the mobile device 101 through call requests sent to the carrier server 112.

At operation 312, the carrier server 112 can complete the call to the mobile device 101. The carrier server 112 can be a terminating service provider, such as a mobile carrier associated with the SIM card installed in the mobile device 101. It will be appreciated that, although not shown, the call may also be communicated through additional, intermediate servers between the call server 108 and the carrier server 112.

Referring to FIG. 4, an incoming call 406 can be received by the mobile device 101. The mobile device 101 can have a respective SIM card associated with a respective mobile carrier and respective mobile plan. For example, the SIM card can be associated with the mobile carrier and may be a normal SIM card or a SIM card having enhanced spam filter or enhanced Caller ID identification. The ability to test both normal and enhanced spam filters through various mobile devices 101 of the system can provide a breadth of knowledge with respect to how different mobile devices 101 will handle calls differently.

The spam filter can determine whether to flag the incoming call 406 as spam. A phone dialer application 408 running on the mobile device 101 can cause the incoming call 406 to be displayed on a user interface of the mobile device 101. For example, the phone dialer application 408 can cause a caller identifier, e.g., a substitute phone number, or a caller identification name associated with the caller identifier, to be displayed. When the spam filter determines that the caller identifier may correspond to a spam call, the phone call can be flagged as spam or potentially spam, and corresponding indications can be displayed on the user interface.

In an embodiment, the call control application 404 running on the mobile device 101 can communicate with an accessibility service 410 of the operating system running on the mobile device 101, to answer the incoming call 406. More particularly, the call control application 404 can use accessibility features of the operating system running on the mobile device 101 to act as if a user is answering the received phone call. The call control application 404 can recognize that incoming call 406 has been received via the accessibility service. In response to such recognition, the call control application 404 can cause the accessibility service to answer the incoming call 406. For example, the call control application 404 may actuate an answer button, virtually, via the accessibility service.

To apply randomization, the call control application 404 may actuate the answer button after a random period of time. For example, rather than causing the accessibility service to answer the call immediately upon receipt of the call by the phone dialer application 408, the call control application 404 can cause the accessibility service to answer the call after a random period of time within a predetermined range following receipt of the phone call. In an embodiment, the predetermined range is between 3 to 5 seconds after the phone call is received. Accordingly, by way of example, the phone call can be answered 4 seconds after receiving the incoming call 406.

The answered phone call will remain in progress until terminated. During the call, the phone dialer application 408 can display the call information, e.g., the caller identifier, on the user interface. At a predetermined time, the call control application 404 can cause the accessibility service to terminate the phone call. More particularly, the call control application 404 can cause the accessibility service to hang up the incoming call 406. For example, the call control application 404 may actuate a hang up button, virtually, via the accessibility service. The phone call can end upon termination by the accessibility service.

To apply randomization, the call control application 404 may actuate the hang up button after a random period of time. For example, rather than causing the accessibility service to terminate the call immediately after the phone dialer application 408 answers the call, the call control application 404 can cause the accessibility service to terminate the call after a random period of time within a predetermined range following answering of the phone call. In an embodiment, the predetermined range is between 15 to 20 seconds after the phone call is answered. Accordingly, by way of example, the phone call can be terminated 17 second after the incoming call 406 is answered.

The call request application 402 can recognize that the call has ended. In response to such recognition, the call request application 402 can retrieve metadata associated with the call from a local cache 412 on the mobile device 101. The metadata can include call parameters. For example, the metadata can include caller identifier data. The caller identifier data can be a string data type. For example, the caller identifier data can include a sequence of characters corresponding to the substitute phone number that was selected for use in making the call. The metadata can include spam flag data. The spam flag data can be a Boolean data type. For example, the spam flag data can include “true,” indicating that the call was flagged as spam, or “false,” indicating that the call was not flagged as spam. The metadata can include the numerical ID of the mobile device 101 that received the call. The metadata can include carrier data. The carrier data can be a string data type. For example, the carrier data can include a sequence of characters corresponding to a name of the mobile carrier associated with the SIM card installed in the mobile device 101. The metadata can include caller identification name data. The caller identification name data can be a string data type. For example, the caller identification name data can include the substitute phone number that was selected for use in making the call, a sequence of characters indicating that the call may be spam, or a sequence of characters corresponding to a name of the caller. The metadata can include additional data of different data types, e.g., string data, Boolean data, time data, integer data, etc. The metadata can describe parameters of the terminated call, including for example: a time at which the phone started ringing, a time at which the call was answered by the accessibility service, a time at which the call was terminated by the accessibility service, whether the call was blocked, a duration of the call, whether the call was presented on the user interface, etc. Accordingly, the data written to the local cache 412 can describe the phone call and, in particular, indicate how the call was handled by the mobile carrier and/or mobile plan associated with the SIM card of the mobile device 101.

Referring to FIGS. 2-4, the communication server 106 can receive, at operation 206, call log data from the mobile device 101. For example, a logging service 414 of the communication server 106 can receive the call log data. When the phone call is answered and terminated by the communication server 106 the call request application 402 can send the call log data retrieved from the local cache 412 of the mobile device 101 to the communication server 106. The call log data can include the information retrieved from the local cache 412, as described above. Accordingly, the call log data can indicate whether the phone call was flagged as spam by the spam filter associated with the mobile device 101.

The communication server 106 can maintain a database associated with phone calls placed to the mobile devices 101 of the system. For example, when the call initiation request 306 is made at operation 204, the communication server 106 can update the database to indicate that a phone call using the caller identifier is “initialized.” When the call is placed by the call server 108, the communication server 106 can update the database to indicate that the phone call is “placed.” Similarly, when the call is terminated, the communication server 106 can update the database to indicate that the phone call is “completed.” The changes in call status can trigger operations of the communication server 106. For example, upon updating the database to indicate that the call is “completed,” the communication server 106 can post the call log data to logging service 414 of the communication server 106.

After the logging service 414 receives the call log data, the communication server 106 can export the call log data for storage. For example, at operation 320 the communication server 106 can export the call log data to the storage server 114 to be stored. The stored data can be accessed for use, e.g., in understanding how the call was handled.

The mobile device 101, e.g., the call request application 402, can send a request 322 to the communication server 106 at an endpoint to communicate to the communication server 106 that the mobile device 101 is ready to receive another call. For example, the request 322 can be a request subsequent to the phone call, and the subsequent request can communicate to the communication server 106 that the mobile device 101 is ready to receive another call, using either from the same caller identifier or another caller identifier. The subsequent request for the subsequent call can include a unique identifier of the mobile device 101. For example, the subsequent request can include the phone number of the mobile device 101 as the unique identifier in parameters of the request.

To apply further randomization, the call initiation request 306 may be sent to the call server 108 after a random period of time. For example, rather than sending the call initiation request 306 immediately upon selection of the caller identifier, the call initiation request 306 can be sent after a random period of time within a predetermined range following receiving the request 304 for the phone call. In an embodiment, the predetermined range is between 20 to 40 seconds after the request 304 for the phone call is received. Accordingly, by way of example, the call initiation request 306 can be sent 22 seconds after receiving the request 304 for the phone call.

Monitoring and tracking the calls made to the mobile device 101 can be used to perform scheduling of calls, and to determine how calls are being handled by the mobile carriers. For example, the log data indicating the caller identifier and whether the call was flagged as spam can be used to understand how the call was displayed, and infer from the data whether such display may influence recipients to not answer calls placed using the caller identifier. The data indicating the call termination time can also be used to schedule subsequent calls using the caller identifier, e.g., to determine whether the caller identifier continues to be flagged as spam.

Scheduling of calls can include weighted randomization to select caller identifiers that are commonly used and not recently tested. In an embodiment, the communication server 106 determines a caller identifier for selection based in part on whether the caller identifier has been used by a user account to make a prior call within a first prior period of time. For example, the user account may be of a caller, e.g., a physician, that placed a call to a recipient, e.g., a patient, through the communication server 106 within the last 6 months. Accordingly, calls placed through the communication server 106 can be logged and looked up when scheduling is performed to prioritize the most recently used caller identifiers over less active or dormant numbers.

The selection may also be in part based on whether the caller identifier has been tested, e.g., used to call the mobile device 101 (or another mobile device in the system) within a second prior period of time. For example, the communication server 106 can determine whether a call has been placed to the mobile device 101 using the caller identifier within the last 45 days. Accordingly, the communication server 106 can avoid testing caller identifiers frequently on the assumption that handling of calls may not change frequently.

In an embodiment, the selection of caller identifiers may also be based on the mobile carrier and mobile plan combinations that the caller identifier has been tested under. For example, a caller identifier may not qualify for testing by a mobile carrier/plan combination if it has already been tested under that mobile carrier/plan combination within a period of time, e.g., on a same day. On the other hand, the communication server 106 may schedule a caller identifier to be tested by all of the mobile device groups and subgroups within the period of time, e.g., on a same day. Accordingly, once a caller identifier is selected for testing, it may be tested against all available carrier/plan combinations in the system, and optionally, may be tested only once by the available carrier/plan combinations in the system over the period of time.

Randomization can be introduced into the selection process. For example, when a caller identifier is selected for testing, it may be used to place calls to different mobile devices 101 at different and randomly selected times over the period of time, e.g., throughout the same day. More particularly, rather than making the calls to the mobile devices 101 using the same caller identifier at simultaneous or sequential times (one after another), the calls may be placed in a staggered manner, randomly throughout the day.

Randomization may also be introduced by randomly selecting the caller identifier for use in making the call from a batch of qualifying caller identifiers. The criteria for qualifying caller identifiers to be tested, as described above, may be met by many caller identifiers that are monitored by the communication server 106. For example, there may be thousands of caller identifiers that have been recently used by physicians to place calls to patients and that have not been recently tested. The system may randomly select a portion of the qualifying caller identifiers, e.g., 100 of the caller identifiers. The system may then randomly select a final result from the portion, to be used to place the call to the mobile device 101. Such randomization can enable staggering of when caller identifiers are used and sent to different mobile carriers, more closely simulating natural, human behavior.

In addition to testing how caller identifiers are handled by mobile carriers in a first phone call, the system can be used to determine how spam flagging of the caller identifier may change over time. Spam flagging is determined by complex algorithms, and the treatment of a phone number by a mobile carrier may change rapidly. For example, it was discovered that a caller identifier may be flagged as spam in the first phone call, and may not be flagged as spam in a second phone call placed shortly after the first phone call. Such discovery suggests that the spam filtering technologies used by mobile carriers adjust the treatment of phone numbers very frequently. The system may be used to detect such time-based treatment of calls to understand whether a particular caller identifier is routinely flagged as spam, or not. Accordingly, in an embodiment, an exception to the no-repeat-testing of caller identifiers policy, described above may be used.

To test for time-based spam flagging of a caller identifier, the caller identifier may be tested repeatedly over time. In an embodiment, based on the phone number being flagged as spam when the phone number was used to call the mobile device 101, e.g., within the second period of time (such as within the last 45 days), the phone number may be selected for use in initiating another phone call to the mobile device 101. The selected caller identifier may be recorded in a redial table, along with information about the mobile carrier/plan that flagged the caller identifier as spam. The redial table can include a date on which the caller identifier was last flagged as spam. Furthermore, the redial table can include a record of a sequential number of days that the caller identifier is flagged as spam. A value of the sequential days may be associated with the caller identifier to determine how many days in a row the caller identifier has been flagged as spam by the mobile carrier.

Caller identifiers from the redial table may be retested at predetermined intervals after the initial phone call. For example, the caller identifier may be used to call the mobile device 4 minutes after being flagged as spam initially, and then every 24 hours for 3 days after the initial call. After each retest, if the subsequent phone call is not flagged as spam by the same mobile carrier, the caller identifier can be removed from the redial table. The sequential days flagged as spam, which is recorded in the redial table, may be reset to zero. If, however, the caller identifier is flagged as spam again after the subsequent phone call to the mobile device 101 associated with the same mobile carrier, the caller identifier can stay on the redial table. In such case, the sequential days flagged as spam value may increase by one.

Caller identifiers on the redial table may take priority over other caller identifiers during the qualification process. Accordingly, the communication server 106 may place calls to mobile devices 101 having SIM cards that require re-testing before making other calls. The data log from redialed phone calls can indicate whether phone numbers continue to be marked as spam over the time intervals tested. Accordingly, the system can be used to determine not only how calls are handled by mobile carriers, but also whether handling of calls by the mobile carriers changes over time.

The exported log data can be used to build data around how mobile carriers treat incoming calls from caller identifiers commonly used by callers, e.g., physicians, to place calls to recipients, e.g., patients, through the communication server 106. More particularly, the exported log data can be used to identify problematic handling of legitimate caller identifiers to facilitate corrective actions.

In an embodiment, an internal administrative database is populated based on the exported log data. For example, the database can be populated with caller identifiers that have been incorrectly flagged as spam. Personnel may view the database to identify the incorrectly handled caller identifiers. The personnel may then reach out to the clinician or the operator of the mobile carrier to notify such entities and promote corrective actions being taken with respect to handling of the caller identifier in the future. Accordingly, the populated database enables the personnel to notify others that the phone call was flagged as spam.

In an embodiment, at operation 208, a notification can be generated in response to the call log data for phone numbers or phone number patterns observed to be flagged as spam. The notification can be a message, e.g., an email or message within the application, that is generated and sent to an entity for use in taking corrective action. For example, the message can be sent to a user of the communication server 106, such as a physician, or to an operator of the mobile carrier, to inform the entity that the phone number is at risk of or was incorrectly flagged. The message can include information about the phone call, such as the caller identifier, to allow the entity to take corrective action. For example, the user of the communication server 106 may change the caller identifier, e.g., by selecting a new substitute phone number that is less likely to be flagged as spam. The operator of the mobile carrier, on the other hand, may alter the call handling policy to ensure that the caller identifier is not flagged as spam in the future.

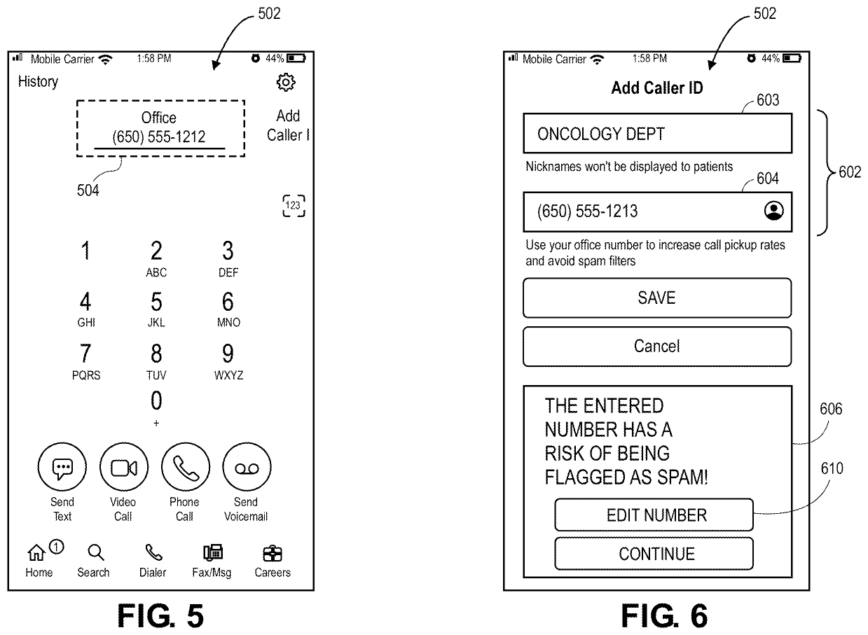

FIGS. 5-6 are pictorial views of a user interface for adding a caller identification profile in accordance with an embodiment of the disclosure. Referring to FIG. 5, in an embodiment, the notification indicating that the phone call may be flagged as spam may be surfaced to a user of the communication server 106 when the user is adding or editing a caller identifier within a caller identification profile. For example, a user interface 502 may be displayed on a computing device of the user when the user is preparing to make a call. The user interface 502 indicates a previously created caller identification profile 504. The previously created caller identification profile can include a caller identification name, e.g., “office,” and a caller identifier, e.g., a substitute phone number associated with an office of the user. The caller identifier can indicate the substitute phone number, rather than the phone number of the computing device that is currently displaying the user interface. More particularly, the user may access the caller identification profile through the user interface 502 to make a phone call to a recipient, such as a patient. Caller identification software on the recipient phone can display the caller identification name and a substitute phone number when the call is received.

Referring to FIG. 6, the user may add or edit a caller identification profile through the user interface. For example, the user can select a tab through the user interface 502 indicating the ability to add the caller identification profile 602. The communication server 106 can receive a request to add the caller identification profile 602 to the user account of the user. For example, the user account can include the caller identification profile 602 associated with the caller identification name “office,” and the user may want to add an additional caller identification profile 504 associated with another caller identification name. The caller identification profile 602 entered in the user interface 502 illustrated in FIG. 6 includes the caller identification name 603 “oncology department.” The entered caller identification name 603 can be a convenient label for the user and may not determine what is displayed to a recipient of an incoming call. It will be appreciated that the user may be a physician who wants the recipient of the call to see an incoming call as originating from the phone number of the oncology department, even though the call originates from a personal mobile computing device. Such substitute number may be advantageous, for example, by allowing the recipient to call the physician back at the oncology department phone number, rather than a personal phone number.

Addition of the caller identification profile 602 can include entry of a caller identifier 604 associated with the caller identification name 603. The caller identifier 604 may be the substitute phone number for the oncology department, for example.

In an embodiment, the caller identifier 604 entered for the caller identification profile 602 may correspond to a caller identifier 604 that may have previously been flagged as spam by the system, or which matches common numeric patterns for other numbers that have been previously flagged as spam by the system. More particularly, the caller identifier 604 for the oncology department may have been previously tested and determined to be on a suspicious list of a particular mobile carrier and/or mobile plan. The system may generate the notification 606 in response to the caller identification profile 602 including the caller identifier 604 that was previously tested. For example, a notification 606 may be displayed on the user interface indicating that the caller identifier 604 entered through the request to add the caller identification profile 602 has an increased risk of being flagged as spam by one or more mobile carriers. The notification 606 can be presented in line with the other user interface fields, or may be presented as a modal, e.g., overlaid on top of the other fields when presented. The notification 606 may include guidance to reduce the risk. For example, the notification text may ask “Is this a real number?” and/or may advise the user to make sure that the caller identifier 604 is an active office or clinic number to avoid spam flags and ensure that patients pick up calls. The notification 606 can be surfaced to the user to allow the user to edit the caller identifier. More particularly, the user may enter or select a different caller identifier 604 to associate with the caller identification profile 602. The notification 606 can be presented when the caller identification profile 602 is being created or edited to mitigate the risk that the substitute phone number used by the user will be viewed by a recipient as being spam. Accordingly, the user can be guided to creating a trustworthy caller identification profile 602 that will lead to a higher likelihood of effective communication between the user, e.g., a physician, and a recipient, e.g., patient.

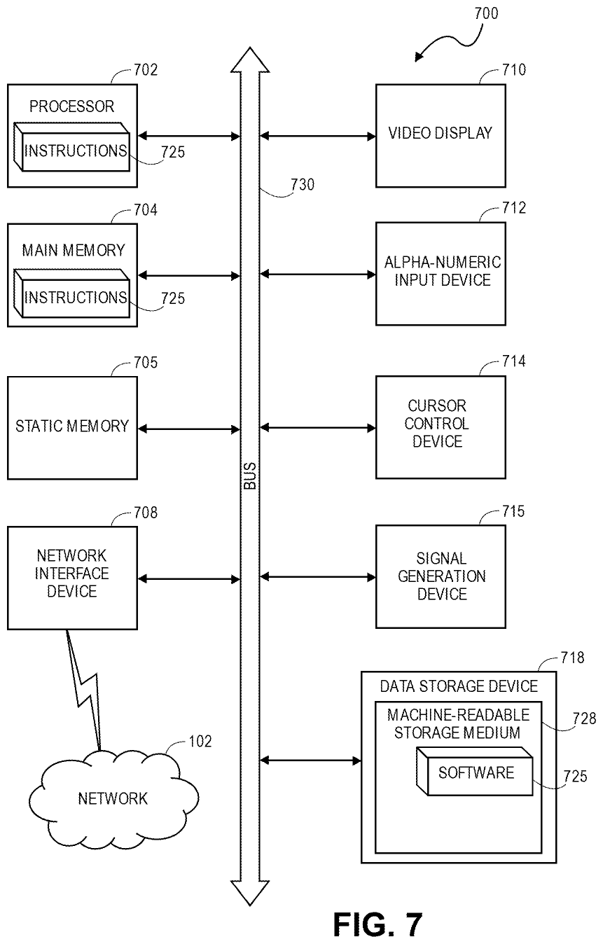

FIG. 7 is a block diagram of an example computing device that may perform one or more of the operations described herein, in accordance with some embodiments. More particularly, computing device 700 may be integrated in any of the servers and/or mobile devices described above to perform any of the described operations. Computing device 700 may be connected to other computing devices in a LAN, an intranet, an extranet, and/or the Internet. The computing device may operate in the capacity of a server machine in the client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 700 may include one or more processing devices (e.g., a processing device, a general purpose processing device, a PLD, etc.) 702, a main memory 704 (e.g., synchronous dynamic random access memory (DRAM), read-only memory (ROM)), a static memory 705 (e.g., flash memory and a data storage device), which may communicate with each other via a bus 730.

The one or more processing devices 702 may be provided by one or more general-purpose processing devices such as a microprocessor, central processing unit, or the like. In an illustrative example, processing device(s) 702 may comprise a complex instruction set computing (CISC) microprocessor, reduced instruction set computing (RISC) microprocessor, very long instruction word (VLIW) microprocessor, or a processing device implementing other instruction sets or processing devices implementing a combination of instruction sets.

Processing device(s) 702 may also comprise one or more special-purpose processing devices such as an application specific integrated circuit (ASIC), a field programmable gate array (FPGA), a digital signal processor (DSP), network processor, or the like. The processing device(s) 702 may be configured to execute the operations described herein, in accordance with one or more aspects of the present disclosure, for performing the operations and steps discussed herein.

Computing device 700 may further include a network interface device 708 which may communicate with the network 102. The computing device 700 also may include a video display unit 710 (e.g., a liquid crystal display (LCD) or a cathode ray tube (CRT)), an alphanumeric input device 712 (e.g., a keyboard), a cursor control device 714 (e.g., a mouse) and an acoustic signal generation device 715 (e.g., a speaker). In one embodiment, video display unit 710, alphanumeric input device 712, and cursor control device 714 may be combined into a single component or device (e.g., an LCD touch screen).

Data storage device 718 may include a non-transitory computer-readable storage medium 728 on which may be stored one or more sets of instructions 725 that may include instructions for carrying out the operations described herein, in accordance with one or more aspects of the present disclosure. Instructions 725 may also reside, completely or at least partially, within main memory 704 and/or within processing device(s) 702 during execution thereof by computing device 700, main memory 704 and processing device(s) 702 also constituting computer-readable media. The instructions 725 may further be transmitted or received over a network 720 via network interface device 708.

While computer-readable storage medium 728 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
receiving, from a mobile device associated with a spam filter, a request for a phone call;
initiating the phone call to the mobile device using a caller identifier;
receiving, from the mobile device, call log data indicating whether the phone call was flagged as spam by the spam filter; and
generating a notification in response to the call log data indicating that the phone call was flagged as spam.

2. The method of claim 1, wherein the request for the phone call is received from a call request application running on the mobile device, and further comprising receiving, from a device authorization server, authentication data authenticating the call request application to permit the mobile device to receive the phone call.

3. The method of claim 1 further comprising selecting the caller identifier for use in initiating the phone call based on whether the caller identifier has been used by a user account to make a prior call within a first prior period of time, and based on whether the caller identifier has been used to call the mobile device within a second prior period of time.

4. The method of claim 3 further comprising selecting the caller identifier for use in initiating the phone call based on the caller identifier being flagged as spam when the caller identifier was used to call the mobile device within the second prior period of time.

5. The method of claim 1, wherein initiating the phone call includes sending a call initiation request after a random period of time within a predetermined time range following receiving the request for the phone call.

6. The method of claim 1, wherein receiving the call log data is in response to determining that the phone call is answered and terminated.

7. The method of claim 6, wherein a call control application running on the mobile device causes an accessibility service of the mobile device to answer the phone call, and wherein the call control application causes the accessibility service to terminate the phone call.

8. The method of claim 7, wherein the call control application causes the accessibility service to terminate the phone call after a random period of time within a predetermined time range following answering the phone call.

9. The method of claim 1 further comprising receiving a request to add a caller identification profile to a user account, wherein the notification is generated in response to the caller identification profile including the caller identifier.

10. The method of claim 1 further comprising receiving, from the mobile device, a subsequent request for a subsequent phone call, wherein the subsequent request includes a unique identifier of the mobile device.

11. A system comprising:
a memory storing instructions; and
one or more processing devices configured to execute the instructions to cause the system to:
receive, from a mobile device associated with a spam filter, a request for a phone call,
initiate the phone call to the mobile device using a caller identifier,
receive, from the mobile device, call log data indicating whether the phone call was flagged as spam by the spam filter, and
generate a notification in response to the call log data indicating that the phone call was flagged as spam.

12. The system of claim 11, wherein initiating the phone call includes sending a call initiation request after a random period of time within a predetermined time range following receiving the request for the phone call.

13. The system of claim 11, wherein receiving the call log data is in response to determining that the phone call is answered and terminated.

14. The system of claim 13, wherein a call control application running on the mobile device causes an accessibility service of the mobile device to answer the phone call, and wherein the call control application causes the accessibility service to terminate the phone call after a random period of time within a predetermined time range following answering the phone call.

15. The system of claim 11, wherein the one or more processing devices are further configured to receive a request to add a caller identification profile to a user account, wherein the notification is generated in response to the caller identification profile including the caller identifier.

16. A non-transitory computer readable storage medium storing instructions executable by one or more processing devices of a system to cause the system to perform a method comprising:
receiving, from a mobile device associated with a spam filter, a request for a phone call;
initiating the phone call to the mobile device using a caller identifier;
receiving, from the mobile device, call log data indicating whether the phone call was flagged as spam by the spam filter; and
generating a notification in response to the call log data indicating that the phone call was flagged as spam.

17. The non-transitory computer readable storage medium of claim 16, wherein initiating the phone call includes sending a call initiation request after a random period of time within a predetermined time range following receiving the request for the phone call.

18. The non-transitory computer readable storage medium of claim 16, wherein receiving the call log data is in response to determining that the phone call is answered and terminated.

19. The non-transitory computer readable storage medium of claim 16, wherein a call control application running on the mobile device causes an accessibility service of the mobile device to answer the phone call, and wherein the call control application causes the accessibility service to terminate the phone call after a random period of time within a predetermined time range following answering the phone call.

20. The non-transitory computer readable storage medium of claim 16 further comprising receiving a request to add a caller identification profile to a user account, wherein the notification is generated in response to the caller identification profile including the caller identifier.
